(19) United States
(12) Patent Application Publication
(10) Pub. No.: US 2015/0059188 A1
(43) Pub. Date: Mar. 5, 2015

(54) CUTTING APPARATUS

(71) Applicants: Erik HAAS, Maitenbeth (DE); Joseph GUERRA, New York, NY (US); Alessandra CORONA, New York, NY (US); Laura SINK, New York, NY (US); Przemek GODYCKI, New York, NY (US); Kat DEVLON, Seguin, TX (US)

(72) Inventors: Erik HAAS, Maitenbeth (DE); Joseph GUERRA, New York, NY (US); Alessandra CORONA, New York, NY (US); Laura SINK, New York, NY (US); Przemek GODYCKI, New York, NY (US); Kat DEVLON, Seguin, TX (US)

(21) Appl. No.: 14/471,965

(22) Filed: Aug. 28, 2014

Related U.S. Application Data
(60) Provisional application No. 61/870,823, filed on Aug. 28, 2013.

(51) Int. Cl. B65H 35/00; B26B 29/06; B32B 38/00

(52) U.S. Cl. CPC B65H 35/008; B32B 38/0004; B65H 35/0026; B26B 29/06
USPC 30/124; 30/279.2

(57) ABSTRACT

An exemplary aspect comprises a tape dispensing member comprising a roller and a tape cutting blade; and a paper cutting blade affixed to the tape dispensing member, the paper cutting blade connecting the body to a protective cover, wherein the protective cover is sufficiently near the body to prevent a user's finger from contacting the paper cutting blade, and wherein the protective cover is sufficiently distant from the body to allow a sheet of paper to pass between the cover and the body and be cut by the paper cutting blade. Another aspect comprises a member having an inside diameter sufficient to encircle a roll of wrapping paper, and having two ends, the member having a gap between the two ends and an elongated opening in one of the two ends; a first cutting blade crossing the gap; and a second cutting blade disposed within the elongated opening.

### CROSS-REFERENCE TO RELATED APPLICATIONS

This application claims priority under 35 U.S.C. 119(e) to U.S. Provisional Patent Application No. 61/870,823, filed Aug. 28, 2013, entitled “Cutting Apparatus and Related Methods.” The entire contents of the above-referenced application are incorporated herein by reference.

### Introduction

An exemplary aspect comprises a paper cutting apparatus having a member with an inside diameter sufficient to encircle a roll of wrapping paper, and having two ends, the member having a gap between the two ends and an elongated opening in one of the two ends; a first cutting blade disposed within and crossing the gap; and a second cutting blade disposed within the elongated opening.

In one or more exemplary embodiments: (1) the first cutting blade cuts in a direction parallel to an axis passing through a roll of wrapping paper encircled by the apparatus; (2) the first cutting blade and the second cutting blade cut in orthogonal directions; and (3) the second cutting blade is sufficiently enclosed within the apparatus to prevent contact with a user's finger.

Another aspect comprises a paper cutting apparatus having a tape dispensing member with a body operable to enclose a roll of tape, and comprising a roller and a tape cutting blade; and a paper cutting blade affixed to the tape dispensing member, the paper cutting blade connecting the body to a protective cover, wherein the protective cover is sufficiently near the body to prevent a user's finger from contacting the paper cutting blade, and wherein the protective cover is sufficiently distant from the body to allow a sheet of paper to pass between the cover and the body and be cut by the paper cutting blade.

In one or more exemplary embodiments: (1) the cover is elongated and has a major axis, and wherein the blade cuts in a direction parallel to the major axis; (2) the cover lies in a plane essentially parallel to a portion of the body to which the cutting blade is connected; and (3) the apparatus further comprises a straight edge on one side of the body, suitable for curling ribbons.

Further aspects, details, and embodiments will be apparent from the drawings and the description below.

### BRIEF DESCRIPTION OF THE DRAWINGS

FIG. 1 depicts an exemplary apparatus embodiment that comprises a cutter for cutting rolled material.

FIG. 2 depicts the cutting blades of the embodiment in FIG. 1 in more detail.

FIG. 3 depicts the embodiment of FIG. 1 from another perspective.

FIG. 4 depicts the embodiment of FIG. 1 enclosing a wrapping paper roll.

FIG. 5 depicts further details of the embodiment of FIG. 1.

FIG. 6 describes exemplary parts, color, material, and finish for the embodiment of FIG. 1.

FIGS. 7-8 depict exemplary usage for the embodiment of FIG. 1.

FIG. 9 depicts exemplary dimensions for the embodiment of FIG. 1.

FIG. 10 describes exemplary parts, color, material, and finish for a tape dispenser embodiment.

FIG. 11 depicts a tape dispenser embodiment with no tape inside, and FIG. 12 depicts an embodiment with a roll of tape inserted.

FIGS. 13-17 depict various perspectives of a tape dispenser embodiment.

### DESCRIPTION OF SELECT EXEMPLARY EMBODIMENTS

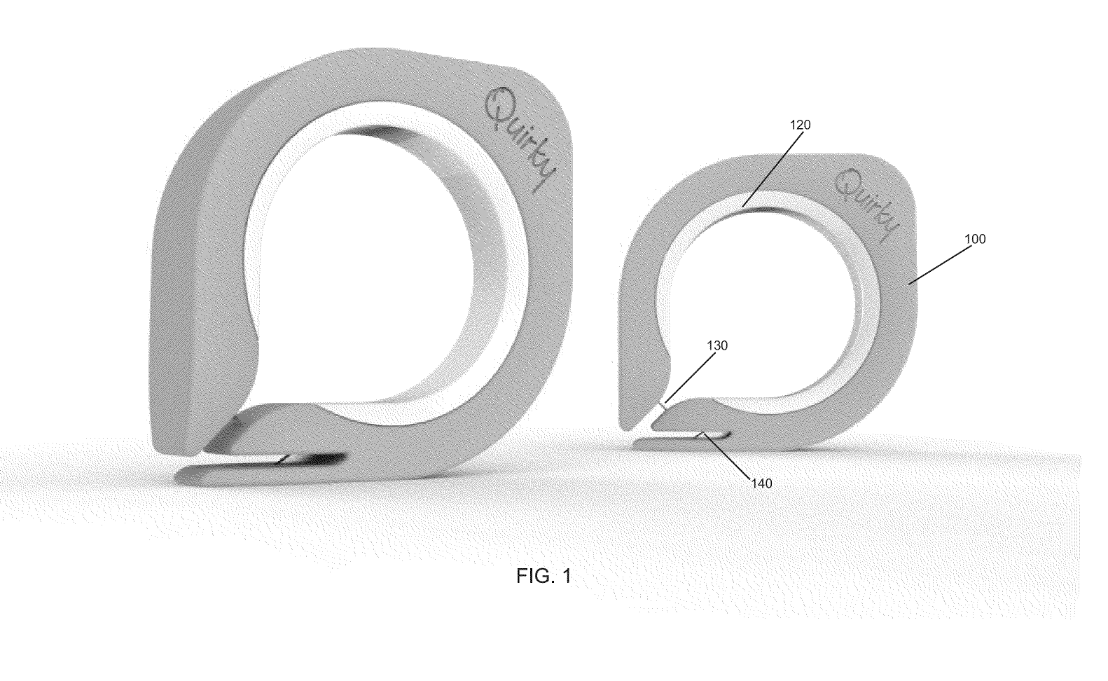

An exemplary apparatus embodiment comprises a cutter for cutting rolled material. See FIG. 1.

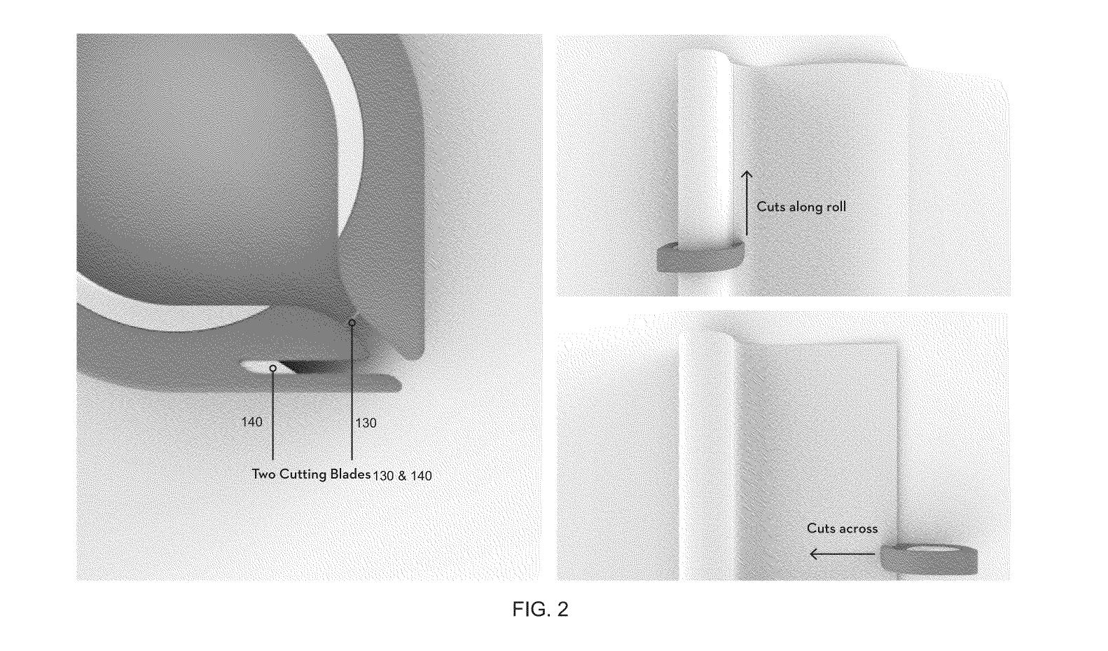

In an exemplary embodiment, the cutter 100 may comprise a blade 130 for cutting material along the length of the roll, and a blade 140 for cutting other material (e.g., material orthogonal to the roll). See FIG. 2. As depicted in FIG. 1, an embodiment of cutter 100 comprises a body with internal circular portion 120, both the body and the circular portion having a coincident gap spanned by blade 130.

In an embodiment, the body also comprises an opening that holds blade 140 at the back of the opening. Blade 140 may be angled away from the front of the opening, to facilitate cutting. See FIG. 2. Since each blade is embedded in the body, the apparatus is safer to use than scissors.

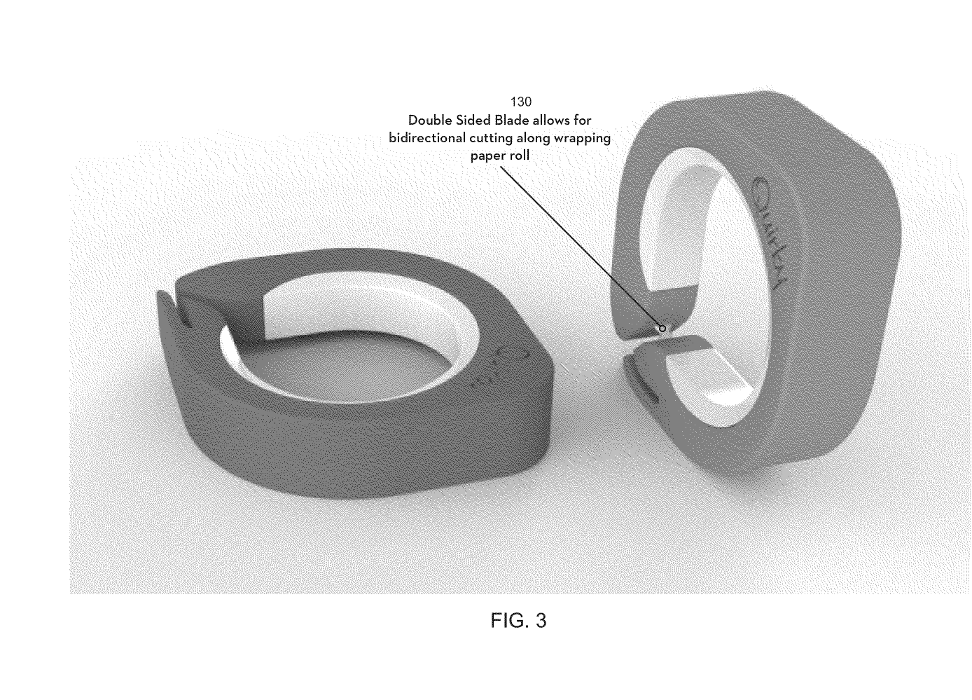

In an embodiment, blade 130 is double-sided allowing for bidirectional cutting. See FIG. 3.

In an embodiment, the diameter of circular portion 120 is selected to slightly exceed the diameter of a roll of material. For example, some gift wrapping paper rolls may have a diameter of 2-3 inches, while other rolls of paper or other material may have diameters of 9 inches or more. Various embodiments may thus have different diameters, depending on the application. Moreover, by using an expansion mechanism (e.g., a hinge and ratchet), the same cutter may be used for rolls of various diameters.

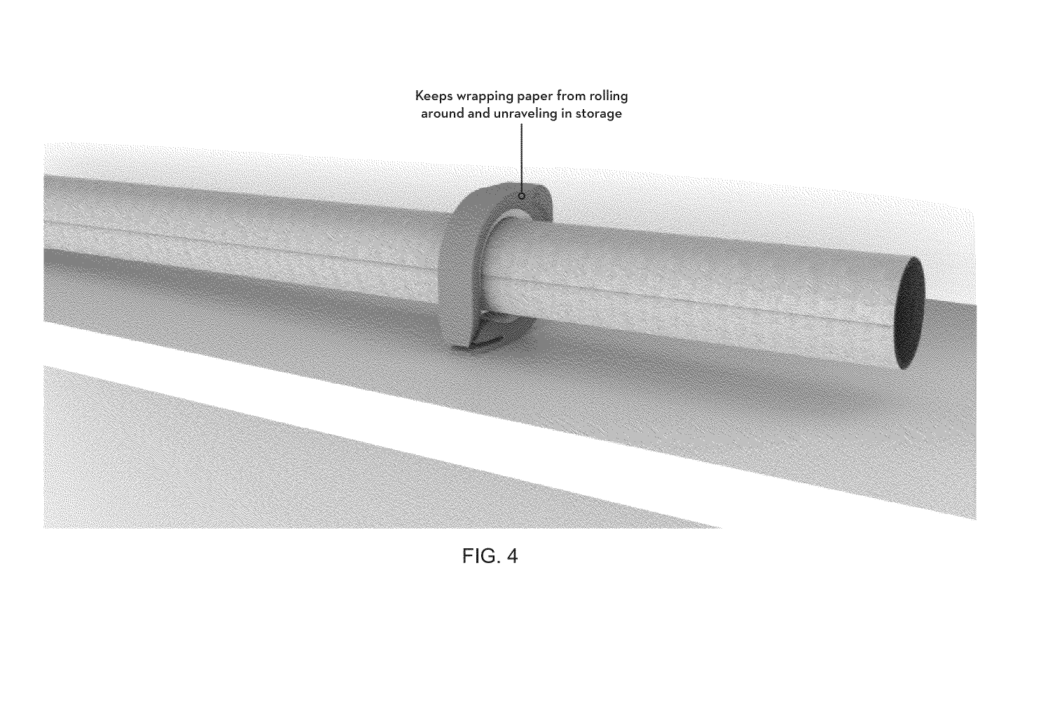

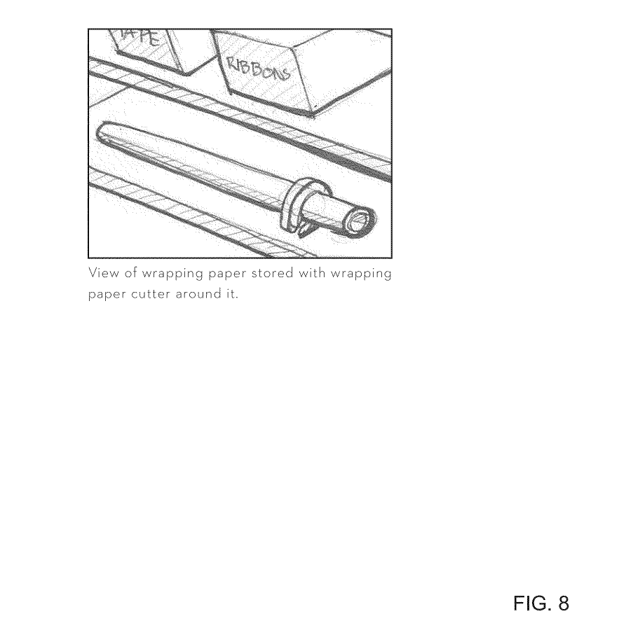

The cutter also may be used to secure a roll of material from unraveling. See FIGS. 4 and 8.

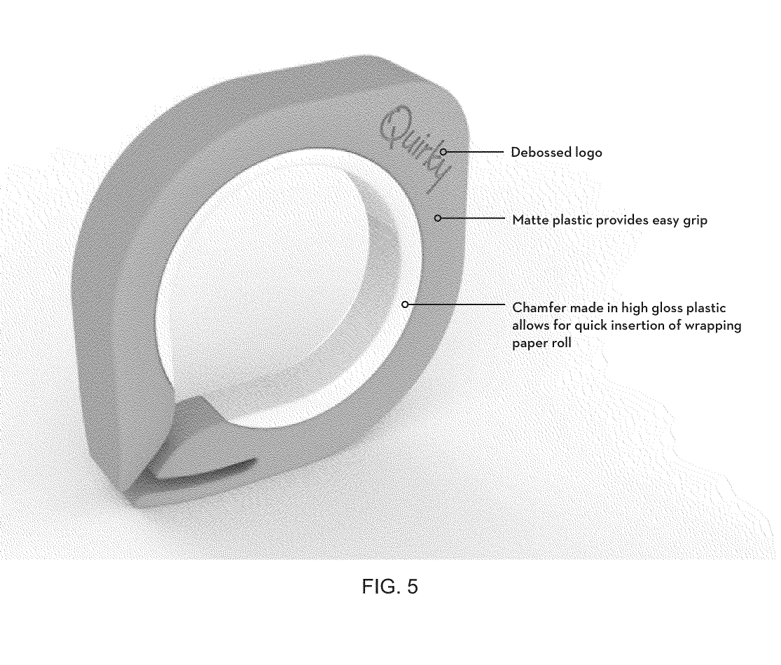

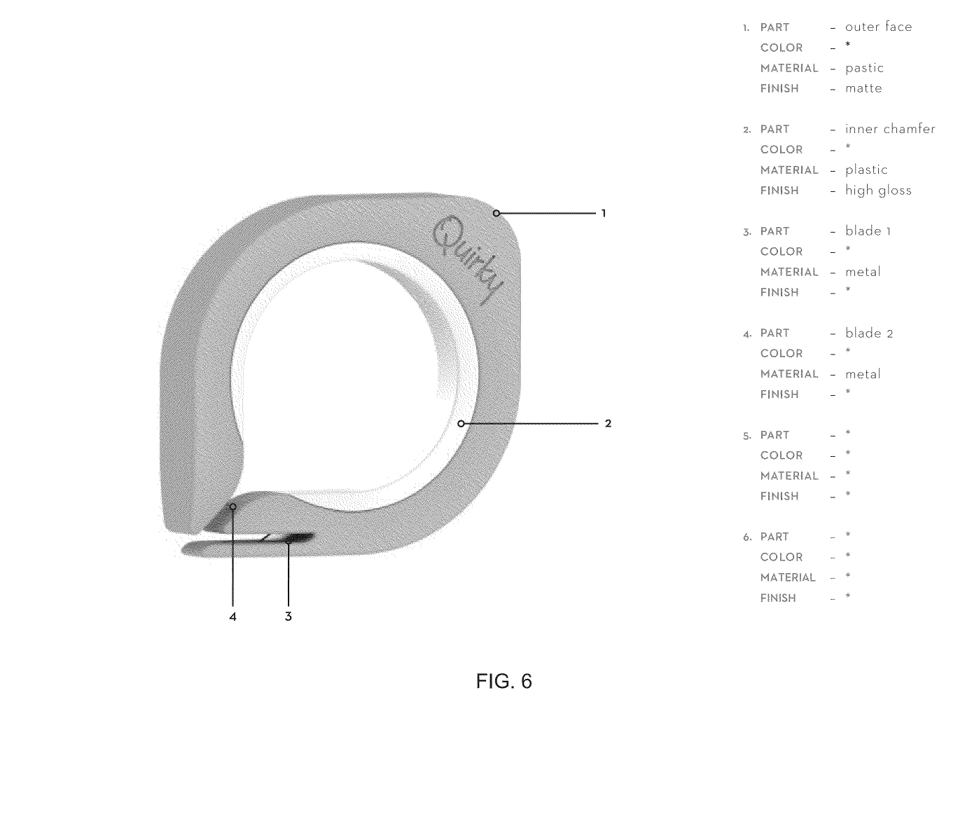

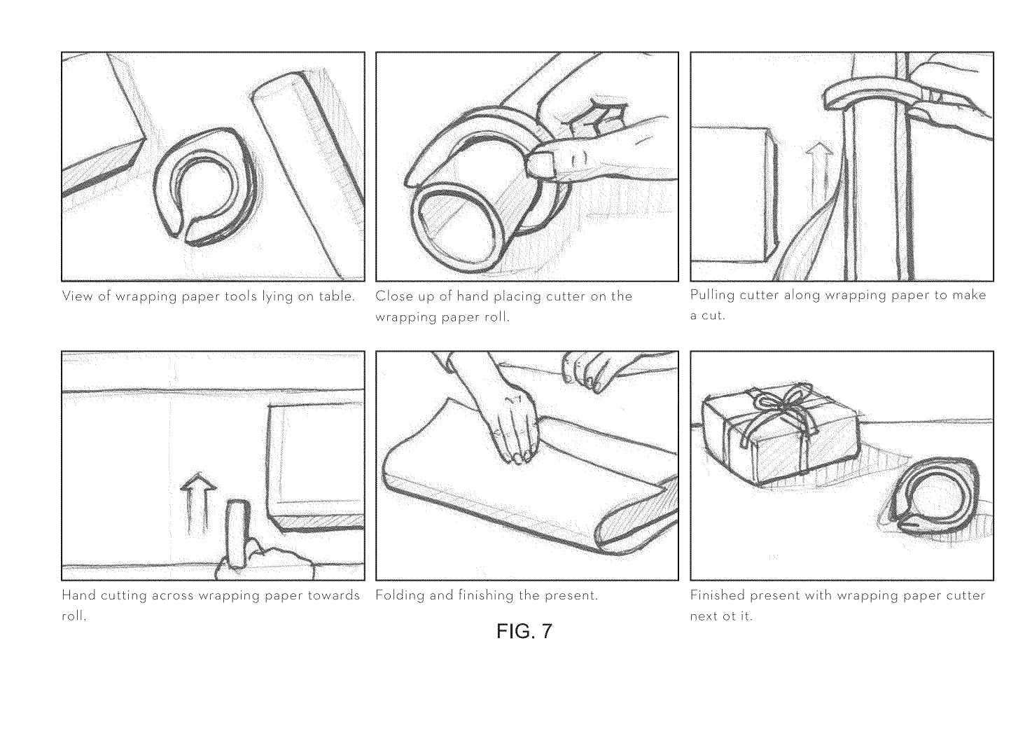

In an embodiment, the body may be covered in matte plastic, in order to provide a secure grip. Circular portion 120 may comprise a high-gloss plastic surface and may be chamfered, in order to facilitate insertion of a roll of material. See FIGS. 5 and 6.

As depicted in FIGS. 7 and 8, a user may pull the cutter along a roll of material (e.g., wrapping paper) in order to make a cut with blade 130. A user may use blade 140 when cutting material in another direction (e.g., orthogonal to the roll).

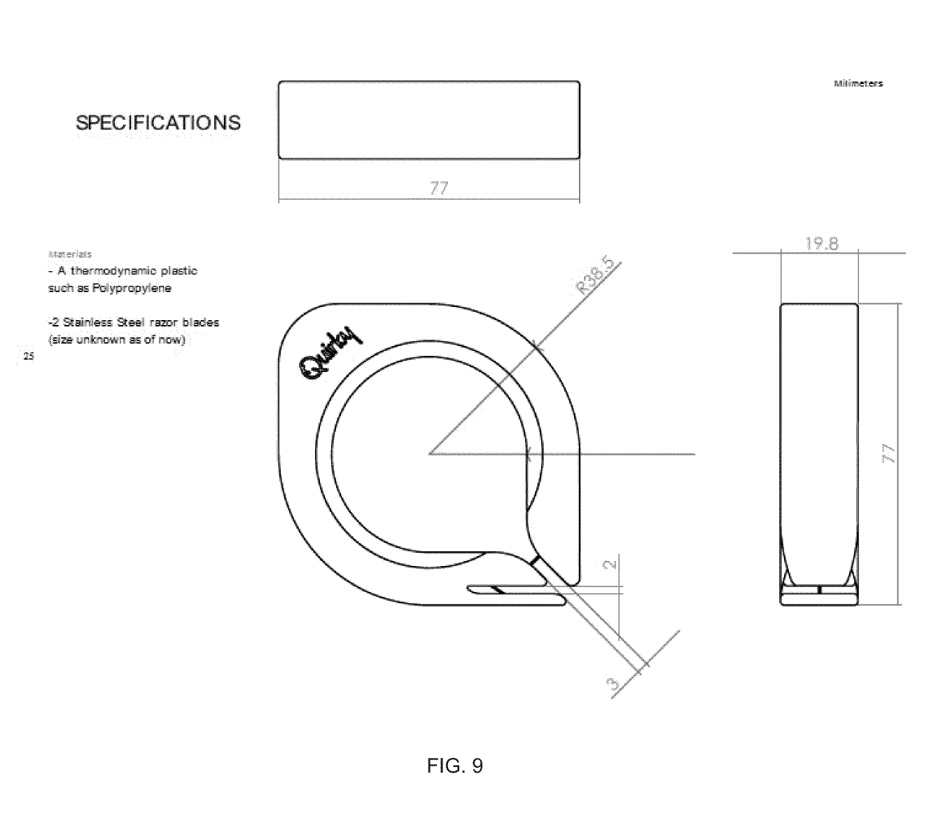

Various materials and dimensions may be used, in various embodiments. For example, as depicted in FIG. 9, the body and circular portion 120 may comprise a thermodynamic plastic such as polypropylene, but those skilled in the art will recognize that many other materials (steel and aluminum, other plastics, wood, etc.) may be used for those components. Similarly, while FIG. 9 depicts stainless steel razor blades as being used for blades 130 and 140, other cutting approaches (such as wires, heated wires, and lasers) may be used interchangeably without departing from the scope of the disclosed embodiments. Dimensions, of course, also may vary, depending on the application for which the cutter is designed. FIG. 9 depicts an exemplary embodiment, wherein the body has a diameter of 77 mm, a depth of 19.8 mm, an external radius of 38.5 mm, and an internal radius (i.e., the radius of circular portion 120) of 25 mm. The opening in which blade 140 sits may have a height of 2 mm, and the gap spanned by blade 130 may have a width of 3 mm.

Another embodiment comprises a tape dispensing apparatus that encloses a tape roll and dispenses the tape along a tape roller. A tape cutting blade cuts the tape once dispensed properly. A second blade, mounted externally, may be used to cut, e.g., wrapping paper. The apparatus may be opened and the tape replaced when necessary.

A hole passes through the center for hand placement, and a TPE cover may be provided to enhance grip.

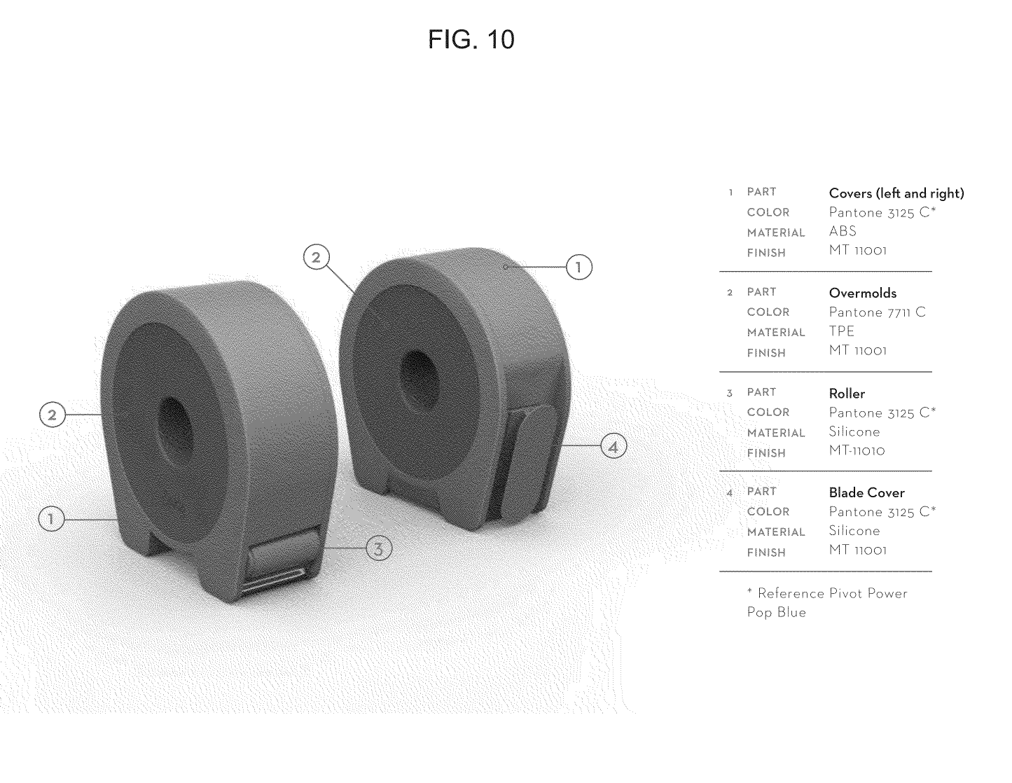

A wrapping paper blade on one side cuts similarly to blade 140, and also is enclosed, for safety, and to guide the paper into the blade. As depicted in FIG. 10 (described below), blade cover 4 may be roughly elliptical, with a major axis and a minor axis. The blade is covered by the blade cover, supports the blade cover, and may be oriented along the major axis of the cover. Those skilled in the art will appreciate that various embodiments may use blade covers of other shapes.

To cut paper with the blade, a user slides the paper between the blade cover and the body of the tape dispenser, and the sliding action causes the blade to cut the paper. Advantageously, the blade is not exposed, and is inaccessible to a user's fingers.

FIG. 10 describes exemplary parts, color, material, and finish for a tape dispenser embodiment. Two cover components may be made of ABS; two overmolds may be made of TPE; and a tape roller and blade cover may be made of silicone. Of course, these materials are intended to be exemplary only. Those skilled in the art will understand that various other materials may be used without departing from the scope of the invention and related embodiments.

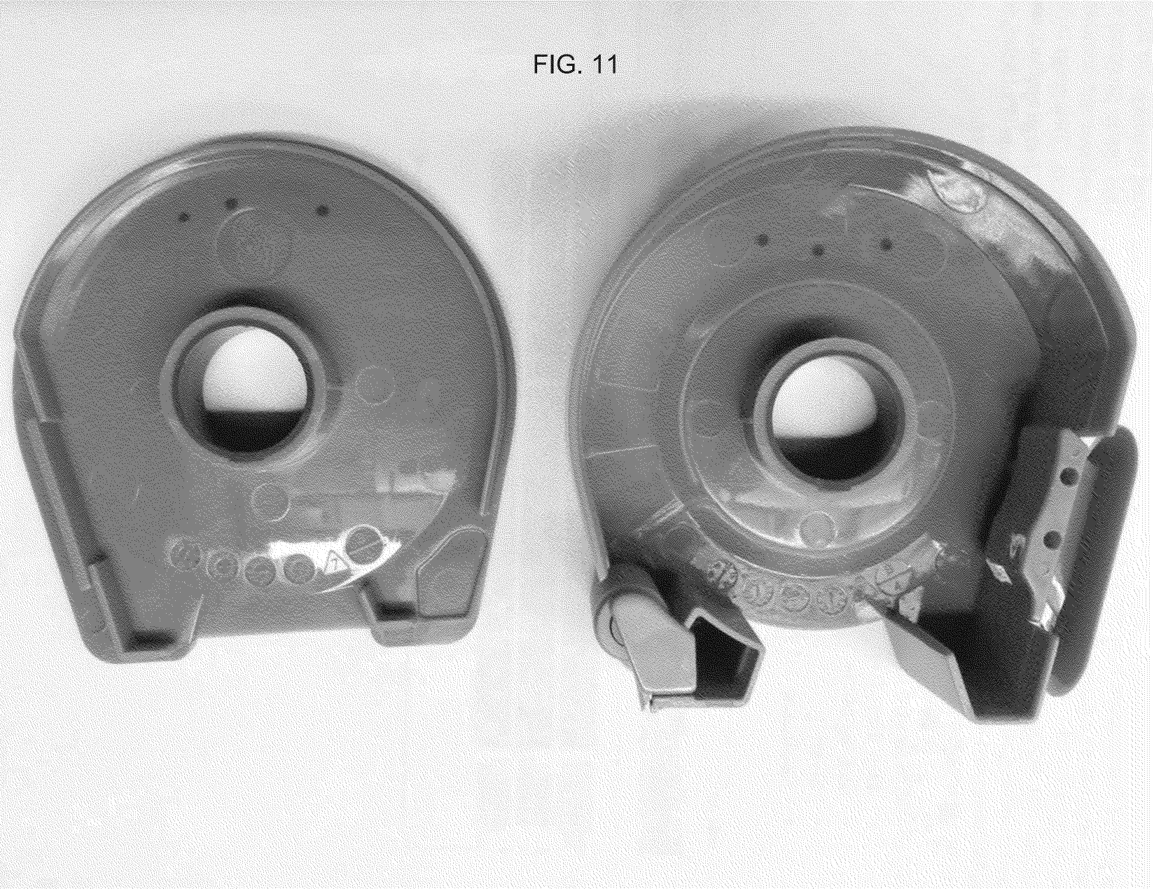

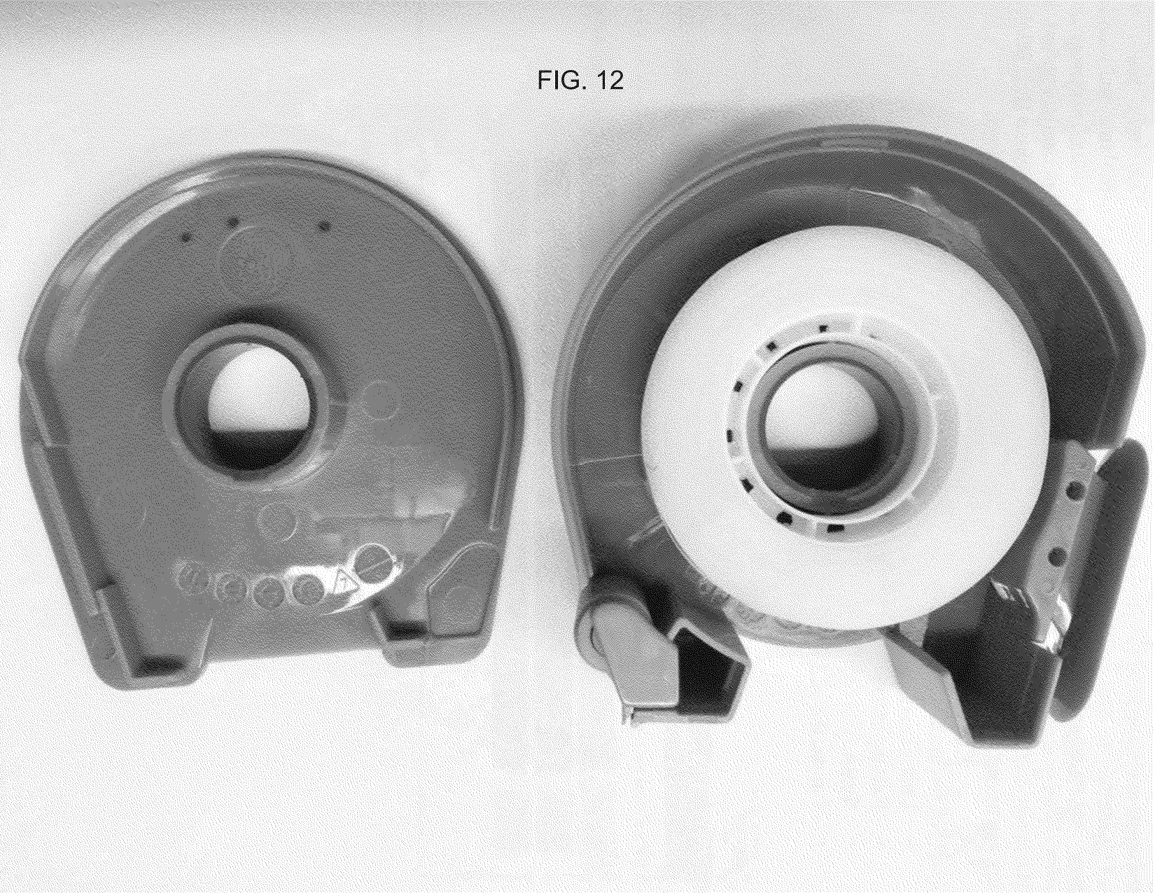

FIG. 11 depicts a tape dispenser embodiment with no tape inside, and FIG. 12 depicts an embodiment with a roll of tape inserted.

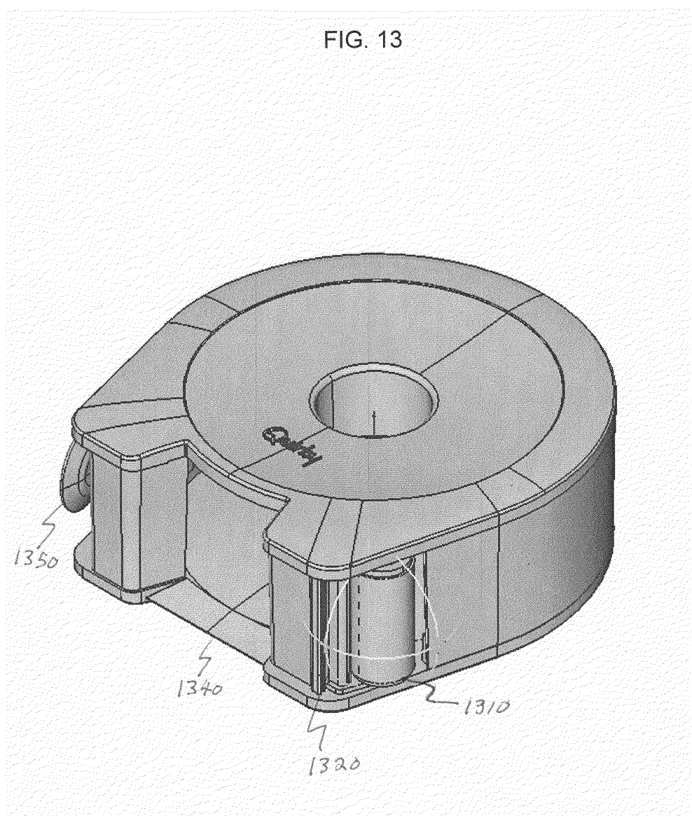

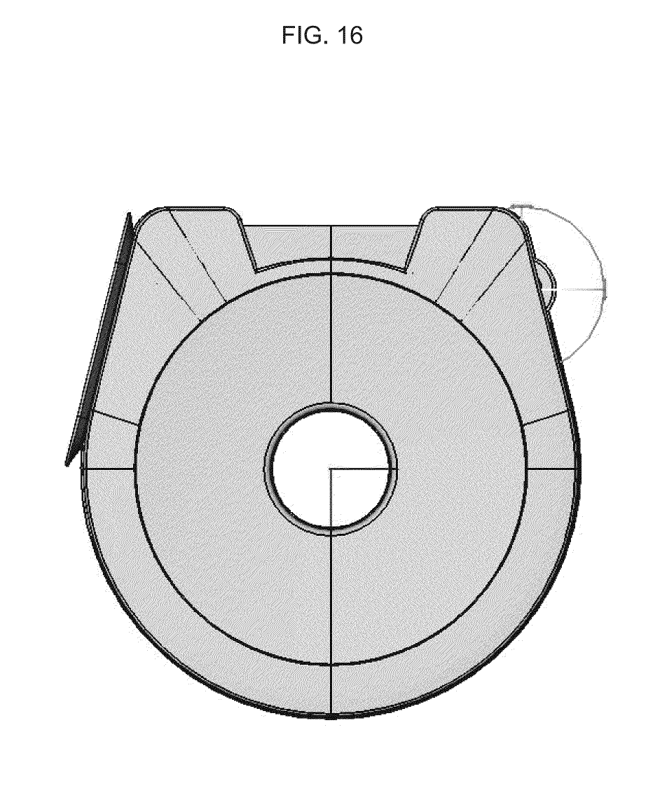

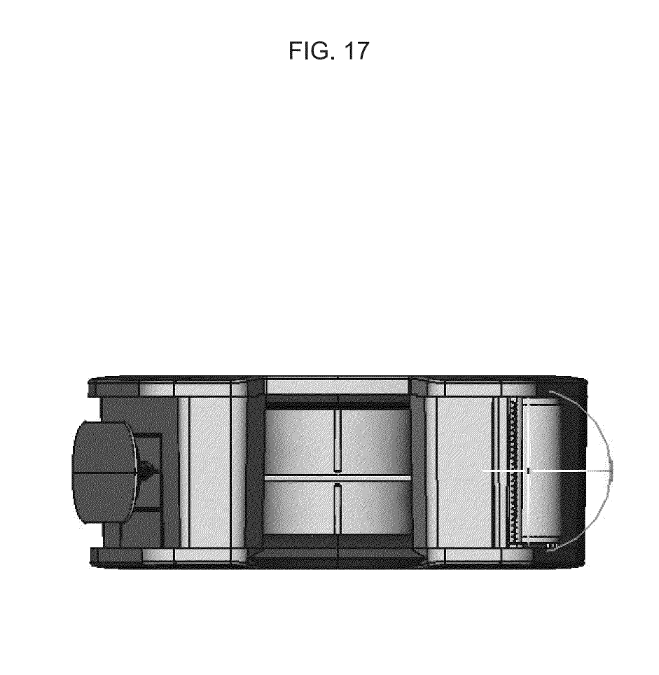

FIGS. 13-17 depict various perspectives of a tape dispenser embodiment.

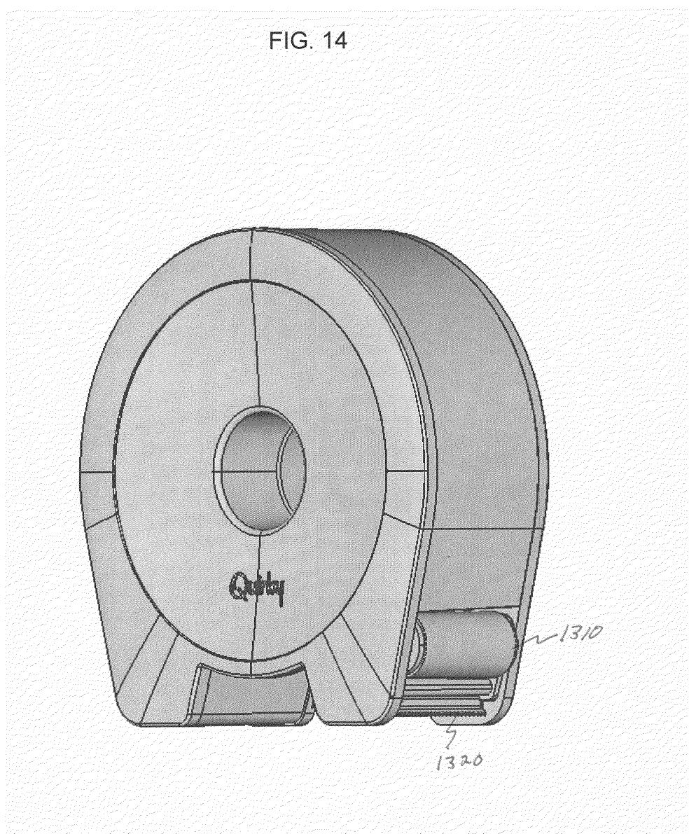

FIGS. 13 and 14 depict a tape roller 1310 and a tape cutting blade 1320 of an exemplary embodiment.

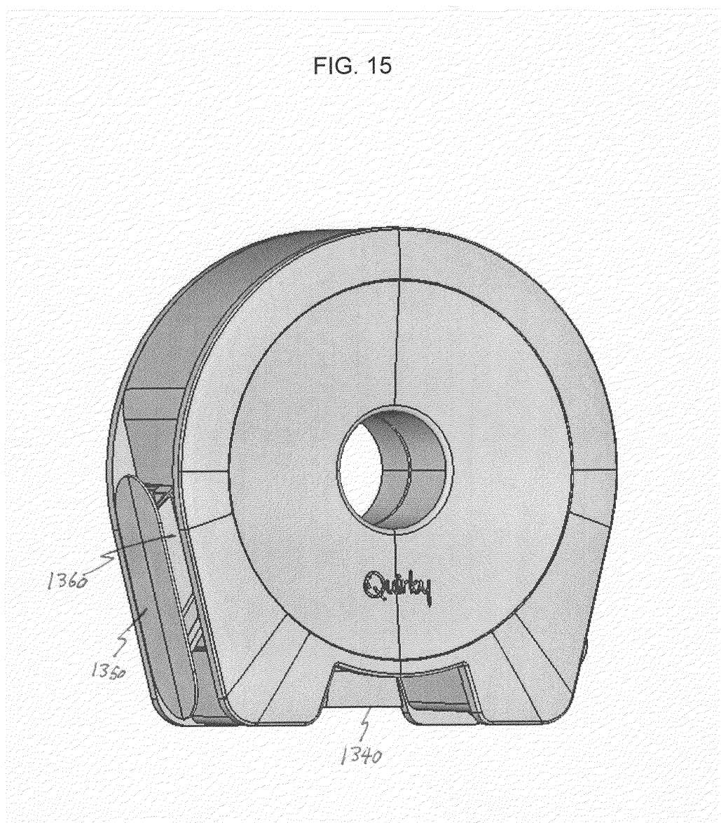

A straight edge 1340, suitable for curling ribbons, of an exemplary embodiment is depicted in FIGS. 13 and 15. In the past, ribbon curling has typically been done with an edge of a pair of scissors.

A paper cutting blade 1360 is depicted in at least FIG. 15, and a blade cover 1350 is depicted in FIGS. 13 and 15.

A tape dispenser embodiment therefore advantageously removes the need for a user to use both a roll of tape and a pair of scissors when wrapping gifts. The functions previously delegated to scissors (cutting paper and curling ribbons) are, in an exemplary embodiment, provided by a single tool that also dispenses tape.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

We claim:

1. A paper cutting apparatus comprising:
a member having an inside diameter sufficient to encircle a roll of wrapping paper, and having two ends, said member having a gap between said two ends and an elongated opening in one of said two ends;
a first cutting blade disposed within and crossing said gap; and
a second cutting blade disposed within said elongated opening.

2. An apparatus as in claim 1, wherein said first cutting blade cuts in a direction parallel to an axis passing through a roll of wrapping paper encircled by said apparatus.

3. An apparatus as in claim 1, wherein said first cutting blade and said second cutting blade cut in orthogonal directions.

4. An apparatus as in claim 1, wherein said second cutting blade is sufficiently enclosed within said apparatus to prevent contact with a user's finger.

5. A paper cutting apparatus comprising:
a tape dispensing member having a body operable to enclose a roll of tape, and comprising a roller and a tape cutting blade; and
a paper cutting blade affixed to said tape dispensing member, said paper cutting blade connecting said body to a protective cover,
wherein said protective cover is sufficiently near said body to prevent a user's finger from contacting said paper cutting blade, and
wherein said protective cover is sufficiently distant from said body to allow a sheet of paper to pass between said cover and said body and be cut by said paper cutting blade.

6. An apparatus as in claim 5, wherein said cover is elongated and has a major axis, and wherein said blade cuts in a direction parallel to said major axis.

7. An apparatus as in claim 5, wherein said cover lies in a plane essentially parallel to a portion of said body to which said cutting blade is connected.

8. An apparatus as in claim 5, further comprising a straight edge on one side of said body, suitable for curling ribbons.
